(19) United States
(12) Patent Application Publication
(10) Pub. No.: US 2009/0247417 A1
(43) Pub. Date: Oct. 1, 2009

(54) METHOD AND SYSTEM FOR DRUG SCREENING

(75) Inventors: Hansjoerg Werner Haas, Burlington (CA); Roger Barry Hertz, Burlington (CA); Brian Wayne Daniels, Weston (CA); Susan Hertz, Burlington (CA); James Robert Ladine, Uxbridge, MA (US); Andreas Lothar Stelzer, Toronto (CA); Blair Daniel Leduc, Mount Hope (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Thermo CRS ltd., Burlington, ON (CA)

(21) Appl. No.: 10/599,985

(22) PCT Filed: Apr. 15, 2005
(86) PCT No.: PCT/CA05/00567

§ 371 Date: Dec. 31, 2008

Related U.S. Application Data
(60) Provisional application No. 60/562,851, filed on Apr. 15, 2004.
(60) Provisional application No. 60/648,225, filed on Jan. 29, 2005.

(51) Int. Cl. C40B 30/02; C40B 60/12

(52) U.S. Cl. 506/8; 506/39

(57) ABSTRACT

The invention provides a system and method for screening drugs from candidate compounds selected from a library. The system includes multiple hardware components and a computer software system for scheduling and coordinating the operations of the hardware components. A user of the system requests a series of assays to be performed on the candidate compounds. Each assay is associated with a test acceptance criteria. Interdependencies of these assays may be specified. The software system schedules the hardware components to run each assay with minimum hardware idle time possible based on the assays requested and the interdependencies of these assays specified. The software system coordinates and directs the flow of samples and data through the system. A decision whether a sample can proceed to the next assay as scheduled may be made automatically based on test acceptance criteria, or manually modified by the user. All assays can be performed in an automated fashion once the samples are provided to the system.

### CROSS-REFERENCE TO RELATED APPLICATIONS

This application claims the benefit of U.S. Provisional Application No. 60/562,851 and U.S. Provisional Application No. 60/648,225, each of which is incorporated herein by reference in its entirety.

### FIELD OF THE INVENTION

The invention relates generally to the field of drug screening. In particular, the invention relates to an integrated system for screening drugs and the method thereof.

### BACKGROUND OF THE INVENTION

In the drug development process, various factors must be considered before a potential drug candidate reaches the final testing stage. Some of these factors are technical such as the rate of absorption of the drug, the duration of bioavailability, the administration route, its potential for side effects etc. In addition, various economic factors are also considered such as the speed and cost of the drug development process, the size of the potential market etc.

The five main technical factors considered in drug development comprise:

1) Absorption of the drug (for example from the gastrointestinal (GI) tract).

2) Distribution of the drug through the body after administration (i.e. concentration in the blood stream, amount of uptake in tissues etc.).

3) Metabolism of the drug (the rate of metabolism of the drug in organs such as the liver; the metabolic stability of the drug in the body).

4) Excretion of the drug (the rate of excretion of the drug through urine or fecal matter).

5) Toxicology of the drug (what, if any, toxic side effects are exhibited by the drug).

These five factors are often summarized as “ADME-Tox”.

It is commonly known that 90% of potential drug compounds fail in the course of development. Of those drug candidates that do fail, the following table associates the reason for such failure:

| Reason for Failure | % |
|---|---|
| Poor ADME properties | 41 |
| Toxicity | 22 |
| Lack of efficacy | 31 |
| Commercialization issues | 6 |

Thus, as can be seen, over 60% of drug failures occur for not meeting the required ADME-Tox criteria.

There are various assays known in the art for conducting ADME-Tox testing. The following table lists some of these assays:

| | Characteristic | Concern addressed | Detection Mode |
|---|---|---|---|
| 1) Absorption | CaCo-2 Assay | active influx or efflux | LC-MS, TEER, Cell |
| | | | Growth |
| | Permeability | membrane permeability | Light Scattering |
| | Solubility | Solubility | Light Scattering |
| | P Glycoprotein | Dosing and BBB passage | Color/Fluorescence/ |
| | | | Lum |
| 2) Distribution | Bioavailability | lack of post intestinal transport | Intrinsic Fluorescence |
| | MDCK Cell Assay | Does brain see this drug | LC-MS |
| 3) Metabolism | Hepatocytes | potency | LC-MS |
| | Microsomes | potency | LC-MS |
| | Cyp Enzymes | potency | LC-MS, Fluorescence/ |
| | | | Color, Isotopic |
| 4) Excretion | Urine Analysis | potency | LC-MS |
| | Fecal Analysis | potency | LC-MS |
| 5) Toxicology | Toxic Metabolite | carcinogenicity | LC-MS |
| | Analysis | | |
| | Genotox | mutagenicity, teratogenicity | Color/bioluminescence |
| | Cytotoxicity | Cytotoxicity | Color/Fluorescence/ |
| | | | Luminescence |
| | HERG Binding (K+ | Cardiac arrhythmia, death | Scintillation Counting/ |
| | Ion Channel) | | AA |
| | Hepatic Enzyme | | |
| | Induction | | |
| | (toxicogenomics) | | |
| | p450 | Hepatic cancer | gene chip |
| | UDP-GT | Hepatic cancer | gene chip |
| | Cyp Enzyme Induction | drug/drug interaction | luciferase reporter gene |
| | Monoamine Oxidase | narrowed market, death | Color/Fluor/Lum |
| | (MAO) | | |
| | UDP-Glucuronyl | large variability in clearance | LC-MS (parent ion scan) |
| | Transferase | | |

The ADME-Tox procedure is, therefore, an important step in the drug screening process. However, for reasons outlined below, ADME-Tox testing is often a rate limiting step in the drug discovery process. Some of these reasons are as follows:

1) Large number of assays: There is an extremely high number of assays to run on screened compounds, yet a compound may be rejected outright if it fails only one of these assays. There are a large number of types of assays, number of tests to be run on each compound, and number of data points necessary to run individual-tests on a single compound.

2) LC-MS is extremely slow: The Liquid Chromatography Mass Spectrometer instrument is typically a rate limiter in many assays, and is the rate limiter for many of the assays. Mass Spectrometry has a lot of dead-time inherent in its operation. These instruments, however, give extremely accurate and high-quality results, so their use is under high demand.

3) Decision-making Complexity: Screening different properties has been handled by different labs, whose activities are not well coordinated. For example, once a compound is screened for ADME-Tox properties, the decision-making process for promoting to for further testing is based on how each organization ranks the ADME-Tox properties. The trade-off between properties depend on therapeutic groups and departments, who find it difficult shift the screening criteria appropriate to various market needs for drugs. There is a high level of expertise, usually in the form of a multi-function team, in order to make these decisions. This is not handled efficiently today.

4) Data Quality: In addition, the data needs to be high quality in order to give scientists confidence that they are making well-informed decisions. The analytical confidence in previous bodies of data is low because of discontinuous steps in experimentation, and because so much of the data was prepared by other groups.

5) Capital Intensive Equipment: The equipment necessary to perform the multiple ADME-Tox assays is very capitally intensive, if high throughput is to be attained. There is a need to use equipment more efficiently, and to improve the throughput of existing equipment.

To solve the “bottleneck” problem associated with known ADME-Tox screening, attempts have been made to modify the order of testing, for example, to assess physico-chemical and ADME-Tox properties of candidate drug compounds early on in the drug discovery process. It is also known to run the various needed ADME-Tox assays in parallel as opposed to a serial manner. In the serial approach, the assays are linked successively with a pre-set selection criteria. The parallel approach comprises running multiple assays simultaneously and although this approach may save time, it results in additional expense since tests are conducted on various compounds that may have been withdrawn from consideration for other reasons (i.e. due to failure of another assay etc.).

Another solution that has been proposed is the use of “in silico” or computer generated models. Of late, a large effort has been made to understand the basis for ADME-Tox properties at a molecular level, with the underlying goal being to predict these properties for new compounds using “in silico” models. Many software solutions are available which can rapidly calculate a variety of physico-chemical and ADME-Tox properties for an entire database with a range of accuracy. These models can be used to help design molecules and are often used as coarse filters for compound selection. However, this predictive technology is not sufficient to eliminate the need for actual laboratory testing.

To increase the efficiency of ADME-Tox screening, various attempts have been made to automate, at least partially, the instrumentation used in the assay procedures. Such instrumentation being used for sample preparation, reformatting and mass spectrometry. However, modern drug discovery is a highly delocalized process and is typically conducted over many sites. With testing occurring at multiple discrete locations on designated equipment, it becomes necessary to invest in software and information technology solutions tailored for each site or the particular hardware equipment. As such, the individual hardware etc. located at various sites is not utilized effectively resulting in considerable idle time.

The foregoing creates challenges and constraints for a method and system for screening drugs. It is an object of the present invention to mitigate or obviate at least one of the above mentioned disadvantages.

### SUMMARY OF INVENTION

The invention provides a system and method for screening drugs from candidate compounds selected from a library. The system includes multiple hardware components and a computer software system for scheduling and coordinating the operations of the hardware components. A user of the system requests a series of assays to be performed on the candidate compounds. Each assay is associated with a test acceptance criteria. Interdependencies of these assays may be specified. The software system schedules the hardware components to run each assay with minimum hardware idle time possible based on the assays requested and the interdependencies of these assays specified. The software system coordinates and directs the flow of samples and data through the system. A decision whether a sample can proceed to the next assay as scheduled may be made automatically based on test acceptance criteria, or manually modified by the user. All assays can be performed in an automated fashion once the samples are provided to the system.

In one aspect of the invention, a system for screening drugs from candidate compounds is provided. The drug screening requires a series of assays, each of the assays having a specified test acceptance criteria. The system comprises a plurality of automated instruments, each of the assays being performed by at least one of the plurality of instruments, a software system for scheduling and coordinating operation of the plurality of automated instruments, wherein the software system receives a request to commence the drug screening from a user of the system, schedules the plurality of automated instruments for performing each of the assays for each candidate compounds, decides whether to pass the each candidate compound based on the test acceptance criteria, and notifies the user of the decision to pass the each candidate compound.

In a feature of this aspect, the software system includes a process integration server, the process integration server being in communication with the plurality of automated instruments and directing operation of the plurality of automated instruments as scheduled by the software system.

In a further feature of the aspect of the invention, the process integration server makes a decision whether the each compound is passed for further testing and makes the decision available for modification by the user.

In another aspect of the invention, there is provided a method for screening drugs from candidate compounds utilizing a plurality of automated instruments for performing a series of assays on each of the candidate compounds, each of the assays having a specified test acceptance criteria. The method comprising the steps of obtaining a schedule of the series of assays to be performed by the plurality of automated instruments, obtaining samples of the candidate compounds, performing the series of assays on the samples in an order specified by the schedule, deciding whether to eliminate a candidate compound from the screening each time when an assay is completed on the candidate compound, and removing the candidate compound from the schedule for further testing when the candidate compound is eliminated, wherein a computer software system is provided to coordinate operations of the plurality of automated instruments and monitor testing status of the assays being performed on the plurality of automated instruments, the software system deciding whether to eliminate the candidate compound based on the test acceptance criteria for the assay performed on the candidate compound, and notifies the user of assay testing results.

In a feature of the other aspect of the invention, the step of deciding whether to eliminate a candidate compound includes the steps of presenting to a second user a decision made by the software system, and receiving modification of the decision from the second user.

In other aspects the invention provides various combinations and subsets of the aspects described above.

### BRIEF DESCRIPTION OF DRAWINGS

For the purposes of description, but not of limitation, the foregoing and other aspects of the invention are explained in greater detail with reference to the accompanying drawings, in which:

FIG. 1 shows schematically major components of a drug screening system and their organization within the system;

FIG. 2 illustrates schematically a reformatter workcell for use in the drug screening system shown in FIG. 1;

FIG. 3 shows schematically an assay workcell for use in the drug screening system shown in FIG. 1;

FIG. 4 provides an overview of a software system, i.e., the software portion of the system of FIG. 1;

FIG. 5 illustrates a drug discovery environment supported by the system shown in FIG. 1;

FIG. 6 shows schematically a laboratory workflow employed in the system shown in FIG. 1;

FIG. 7 shows an exemplary screen display that a user of the system of FIG. 1 can use to define a screening campaign;

FIG. 8 is another exemplary screen display produced by the software system for a user to confirm or modify a decision on passing an assay;

FIG. 9 shows in detail a portion of the screen campaign that is run in a combination of parallel and serial steps;

FIG. 10 shows an exemplary scheduling diagram produced by the software system shown in FIG. 4;

FIG. 11 is a flow chart of a drug screening process that is implemented by the system shown in FIG. 1;

FIG. 12A illustrates schematically a process of performing an assay in the drug discovery environment shown in FIG. 5;

FIG. 12B shows steps of the process of FIG. 12A in a flowchart format; and

FIG. 13 illustrates schematically the gradual reduction or elimination of compound candidates in a screening campaign conducted using the drug screening system shown in FIG. 1.

### DETAILED DESCRIPTION OF THE INVENTION

The description which follows and the embodiments described therein are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

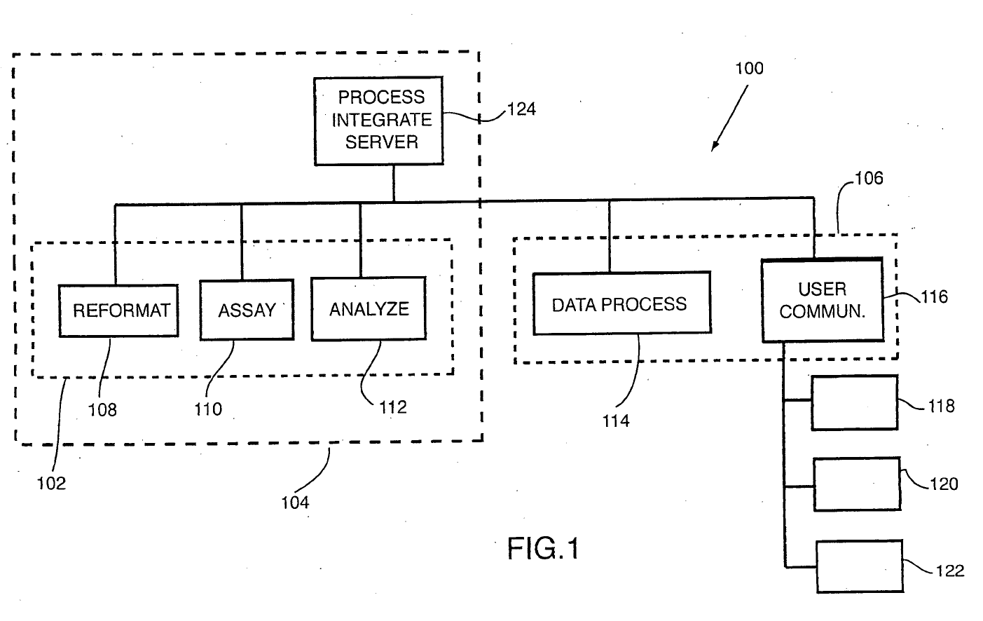

The present invention relates to a system and method for screening drugs. FIG. 1 shows schematically the architecture of a drug screening system 100. Drug screening system 100 is an integrated, modular system. Conceptually, drug screening system 100 may be considered to consist of hardware, automation software and information technology (IT) components. The hardware portion 102 provides hardware resources such as workcells and workstations dedicated for various experiment processes implemented by the system. The coordination of operations of and processes between the hardware components is provided by the software components 104. The IT components 106 coordinate information flow and process of data, including data acquisition, processing, analysis and storage and retrieval, as well as user communication. The hardware components may have multiple basic units, each of which can be combined for parallelization of processes, utilizing a common container/carrier for the samples. The modular design of system 100 allows adding more hardware components as necessary or desirable, or substituting one for another. The hardware components may also be housed in the same enclosure for self-contained operation and centralized control.

FIG. 1 shows three hardware components, although as explained above, the system 100 is not restricted to these three hardware components. In fact, the hardware, although conceptually may be divided into different components, may all be enclosed in one enclosure and may share physical platforms or spaces when conducting experiments or performing sample preparation or analysis. The hardware components shown in FIG. 1 include a reformatter workcell 108 for preparing sample plates for each requested assay, an assay workcell 110, such as an ADME-Tox workcell, for conducting experiments, and an analyzer station 112, such as an LC/MS workstation, for analyzing and collecting data.

The IT components include a data process module 114 for processing and analyzing data and coordinating the flow of data through the system as will be described in greater detail below. Conceptually, the user communication subsystem 116 is considered an IT component. A user communication subsystem 116 provides services allowing a user of the system to interact with the system. A user may, for example, enter or upload test plans review test status, enter or modify test acceptance criteria, for example. The user communication subsystem 116 may also provide a display terminal 118 for providing system status information, such as availability of hardware resources, status of experiments, test results or other relevant information to a user, such as scientists, laboratory technician, facility staff or other department or institution personnel. The system may use a display terminal 118 for displaying system and experiment information to a user. The system may also provide an administration workstation 120, allowing a user to interact with the system, so that the user may, for example, control the operation of the system, the workflow executed by the system, or monitor the progress of various experiments performed by the hardware resources. In addition, the system may also provide remote access to a user in the form of an information portal 122, a remote display of a user interface that provides system information and allows a user to access the system using the user's own computer resources, whether as a computer workstation or as a handheld computer, that may or may not have an operating system compatible with that running on a computer system on which the user communication subsystem 116 runs.

The software components 104 include a process integration server 124, which is the command center for coordinating and orchestrating the operation of the hardware components. The software components also include various instrument automation components. For each hardware component, there can be provided a corresponding software component for the automation of the hardware component. There can also be a corresponding data acquisition module for each of the hardware components for acquiring experimental data and coordinating the data flow from hardware to software. As will be described in great detail below, the software components 104 also include a scheduler (not shown in FIG. 1) that schedules experiments according to test plans and availability of hardware resources.

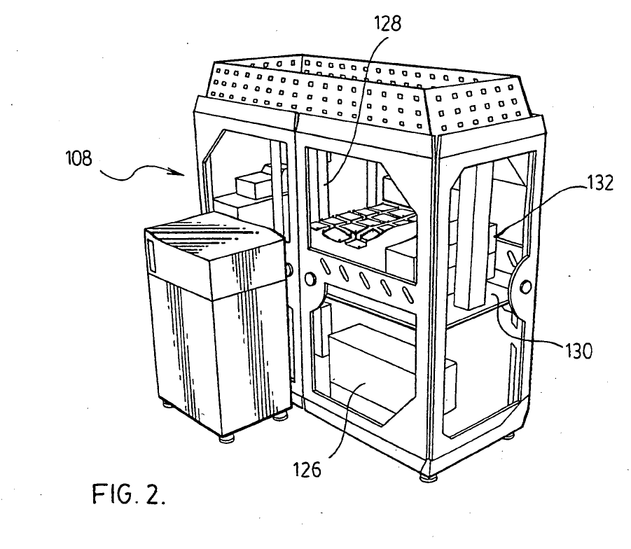

FIG. 2 illustrates schematically a reformatter workcell 108. Like other hardware components, a reformatter workcell 108 generally includes robotic control and automation devices, liquid handling devices, sample storage unit and sample processing unit. These main components provide the necessary functions of sample preparation and processing, namely, preparation and processing of samples for experiments from a pool of samples, such as a library or a sub-library (“reformatting”).

FIG. 2 shows a reformatter workcell 108 having a refrigerated storage 126, or a refrigerated incubator (controlled environment), for storing samples. Robotic plate handling devices, such as robot arm 128, facilitate automated plate handling, and in particular, provide the capability of moving automatically a sample plate from refrigerated storage 126 to different locations within the workcell, such as a lid park (not shown) for de-lidding, a deck or plate platform 130 of liquid handler 132 for further liquid handling such as “cherry picking”. A sub-library in general consists of multiple plates with multiple samples in each well of a plate. “Cherry, picking” refers to the step of choosing samples in a random order from individual wells of a plate from a sub-library and transferring the chosen samples to a specific well in a new microplate. Liquid handler 132 enables the system to cherry pick samples and to replicate these plates when needed. Liquid handler 132 in general automates liquid handling such as reagent addition, dilution, transfer and dispense.

Reformatter workcell 108 is also equipped with laboratory process accessories for automating those laboratory procedures other than liquid handling and sample movement. For example, a reformatter workcell 108 may have identification means for identifying sample plates. In one configuration, a bar code labeler (not shown) is provided for affixing barcode labels to plates and a barcode reader (not shown) is provided for scanning barcode labels. Other suitable identification readers, such as electronic chip readers may also be provided where electronic chip technology or other identification technology is used for identifying sample plates. These labeling and reading devices may be used to “check in” a plate when the plate is placed in a reformatter workcell 108 and “check out” the plate upon its removal from the workcell. This enables the system 100 to track the location of each plate as it moves from workcell to workcell at each step of a drug screening process. For different applications and depending on the needs, reformatter workcell 108 may also have instrument accessories for providing plate cooling, plate mixing station, and plate sealing.

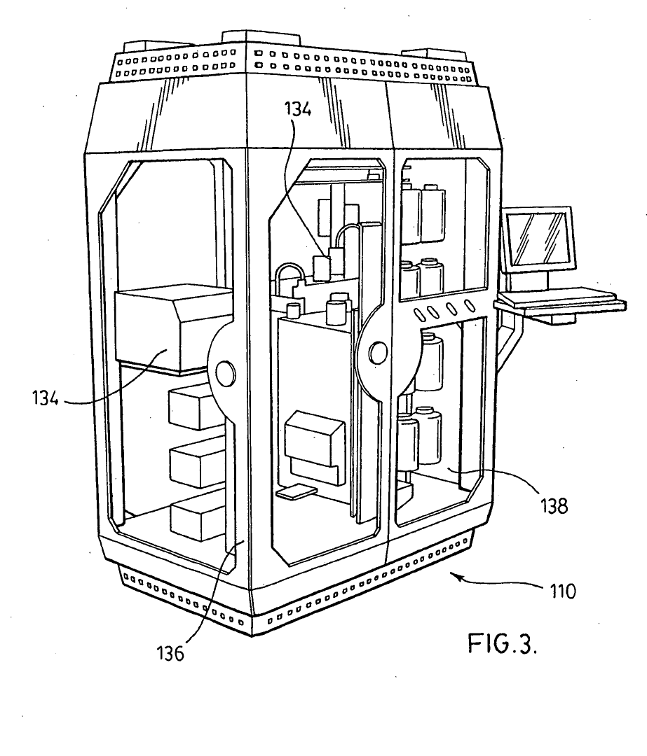

FIG. 3 shows schematically an assay workcell 110. In general, assay workcell 110 is a multifunctional workcell that is capable of conducting a variety of experiments. An assay workcell 110 has a mover 134 or movers to relocate microplates to different instruments/stations 136 within the cell. Mover 134 is controlled by robotic devices to minimize human intervention. These instruments/stations are able to run a cross section of microplate in-vitro ADME-Tox assays, with minimal re-configuration. An assay workcell 110 may have its own liquid handlers (not shown) to supplement the needs of, for example, reagent dilution, transfer and dispense while experiments are conducted within the unit. In addition to plate identification means and instrument accessories described above, assay workcell 110 may also have other laboratory process accessories, such as components for maintaining temperature of the samples or for providing agitation of sample plate holders.

Assay workcell 110 is preferably enclosed for safety, reliability and protection from the external environment. FIG. 3 shows an enclosure shell 138, with transparent windows 140 for easy monitoring. Assay workcell 110 is designed to have a minimized footprint by maximizing the utilizable space. Preferably, assay workcell 110 is self-contained and small enough to be easily relocated between laboratories.

An analyzer station 112 may be provided for analyzing the test results and collecting experimental data. For example, analyzer station 112 may be a High Throughput LC/MS workstation, available from Thermo Electron Corporation. Such a workstation enables its users to automatically analyze a large number of microplate plate samples at high speed with LC/MS technology. Samples from microplates may be injected at random into an LC/MS at high speeds. Instrument such as an automated incubator (controlled environment) can also be used to supply these plates at random with high speed to an auto-sampler (not shown) that will inject samples into an LC/MS. A data acquisition unit (not shown) connected to analyzer station 112 captures data generated by analyzer station 112, such as a High Throughput LC/MS workstation, and transmits the captured data to process integration server 124 for further processing.

Advantageously, a common container or carrier of sample plates is used among all hardware components. This allows seamless transfer between the different ADME-Tox processes. Instead of having to reload sample plates into a different container when the samples are transferred from one workcell to another workcell, the entire container may be removed from one workcell and inserted (or plugged) into receptors at another workcell designed for the same container. This also facilitates further automation of transport of samples from workcell to workcell. For example, when the experiment requires the transfer of samples from one workcell to another workcell, a robotic device may remove the container from the first workcell and insert it into the second workcell, as directed by the process integration server 124 and the work-cell's own automation software.

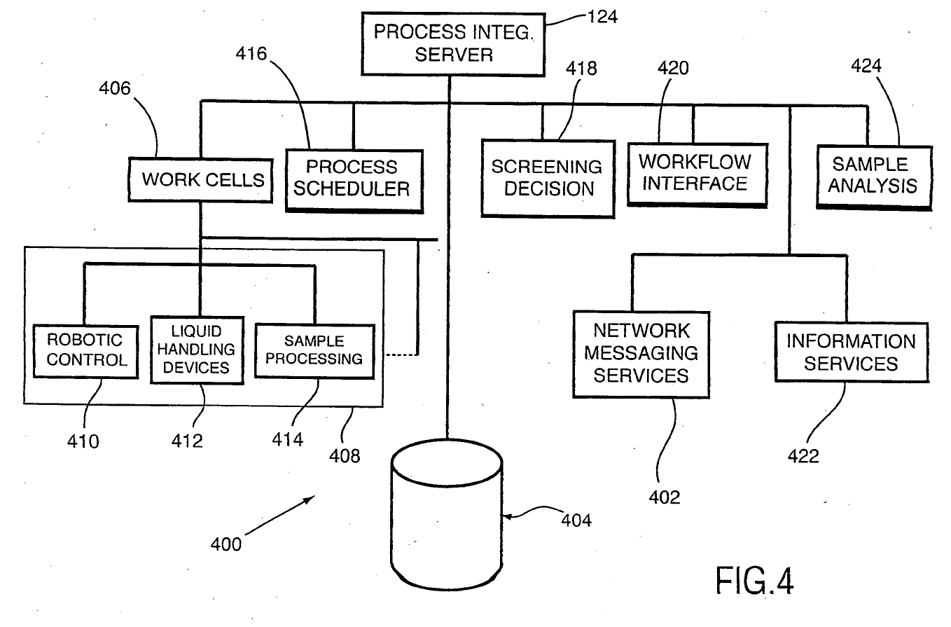

FIG. 4 provides an overview of a software system 400, i.e., the automation software portion and IT software portion of system 100 in greater detail. Components not shown in FIG. 1 for clarity or emphasis are now shown in FIG. 4. The software system 400 provides the organization and control of operations of hardware resources used within a drug-discovery or pharmaceutical laboratory, particularly those engaged in the secondary screening of candidate drug compounds for adverse characteristics such as ADME-Tox. The software implements processes enabling the identification of compounds whose therapeutic suitability warrants further clinical testing.

The software system 400 has a number of components, for controlling and integrating the operation of hardware components and the process, and for providing data processing capability and user control. Each of the hardware units operates independently at the instrument level as directed by its own software. At the command center is process integration server 124. The work units communicate through a network messaging module 402 to supply information requests, instrument status, and results to various data processing and logic process units as will be described below and through these data processing and logic process units to the process integration server 124. The network messaging module 402 exchanges messages with various hardware subsystems to start, stop, resume operations of the hardware and data collection and to monitor hardware subsystems, and are generally for the monitoring and control of hardware units. The network messaging module 402 also exchanges messages with user communication subsystem 116 for receiving inputs from and communicating output to users. These messages may be in the form of any network messages conforming to a suitable protocol or protocols, such as web service messages in http (hypertext transfer protocol) format, or electronic control signals if a hardware unit is directly controllable by software system 400. Process integration server 124 provides a means of governance over these software service components that directly control equipment and instruments within a laboratory. Therefore, process integration server 124 forms a framework by coordinating a set of laboratory service components, which collectively execute the objectives of a laboratory screening process.

Data warehouse 404 is a data depository that provides a unified database for the system 100. It stores raw data as acquired from each workcell during experiments or upon completion of experiments. A complete audit trail of each experiment may be collected at each hardware unit and archived in data warehouse 404. Processed data, i.e., data generated from a data analysis operation on the raw data, are also stored in data warehouse 404. For easy storage and retrieval as well as for access control, the database may be a secure SQL database. A Laboratory Information Management System (LIMS) may also be built on top of the database to provide further integration and unification of data acquired in any given screening campaign or in multiple screening campaigns.

Referring to FIG. 4, corresponding to each hardware unit, such as reformatter workcell 108, assay workcell 110, and analyzer station 112, there is an instrument cell subsystem 406. Instrument cells are subsystems within the overall laboratory that host specific sets of laboratory equipment, such as robotic devices, detection devices, sample processing, and liquid handling devices. Software subsystem for an instrument cell, namely, instrument cell subsystem 406, provides the services of interconnection between process integration server 124 and the instrument subsystem. The hardware instrument cell and its software instrument cell subsystem together constitute a laboratory instrument subsystem.

The software portion, namely, instrument cell subsystem 406 controls and monitors the operation of the corresponding hardware unit and is responsible for the automated operation, or “walk-away” operation, of each hardware unit. A user sets up an experiment by supplying the required samples and the requisite instructions on experimental procedures to be carried out. Instrument cell subsystem 406 directs the corresponding hardware instrument to carry out the steps without further human intervention.

Acquisition of experiment data is also automated. A hardware instrument may be provided with its own dedicated data acquisition software. The software application may be executing on a processor physically located in the vicinity of the hardware unit, or may be executing on a processor remote from the hardware unit, such as a central computer located in a control room. The hardware unit may also be serviced by a generic software application that is designed for servicing all hardware units operated by a laboratory or an institution. Instrument cell subsystem 406 may also be responsible for capturing data from the experiment or samples, if the hardware instrument is not equipped with its data acquisition software.

FIG. 4 shows the details of an instrument cell subsystem 406 for a reformatter workcell 108, namely the reformatter subsystem 408. The reformatter subsystem 408 has a robotic control module 410 for controlling the robotic devices, namely robot arm 128, a liquid handling module 412 for controlling the liquid handling devices, namely liquid handler 132, and a laboratory process module 420 for performing laboratory processes, such as controlling sample temperature or labeling and sealing sample containers. Where identification labeling means, such as bar code reader, is provided, laboratory process module 420 is also responsible for “checking in” and “checking out” sample plates and thereby enabling the system 100 to track the movement of each sample plates within the system.

Instrument cell subsystems for other instrument cells have a similar or same structure, although it will be appreciated that the function of each instrument cell subsystem will vary. Further, it will be appreciated that for other types of workcells, other software modules may be required. For example, for an analyzer station 112, there will be a data acquisition module. If the analyzer station 112 has its own dedicated data acquisition software application, the data acquisition module will only be responsible for interfacing the dedicated data acquisition software application with process integration server 124; otherwise, the data acquisition module will also be responsible for interacting with data acquisition devices of the analyzer station 112 to capture data and transmit the captured data to integration server 124.

Process scheduler 416 is a software service subsystem that applies laboratory experiment rules to the construction of a laboratory workflow flow schedule. As will be described in greater detail below, a laboratory workflow refers to the flow of samples and data through the drug discovery system 100 as well as human interaction with the samples and data. For a screening campaign, a user such as a research scientist, defines a series of assays to be run, the test acceptance criteria for each assay, and interdependencies of the assays.

Specifying the interdependencies of the assays permits optimum scheduling of hardware resources, in particular, it will allow the process scheduler 416 to determine which assays may be run in parallel and which assays need to be run in serial and in what order. For example, it may be desirable to run all toxic assays first. Any compound that fails a toxic assay may be rejected immediately. Knowing the dependency as described above, the process scheduler 416 may schedule to run all toxic assays in parallel and as the first link in a chain of series of tests.

Once the order of running the specified series of assays is determined from the interdependencies and priorities, the process scheduler 416 assigns these assays to different hardware units, based on the assays to be conducted and the availability of required hardware resources. Process scheduler 416 also schedules the anticipated time slot during which an assay is to be run using a specific hardware unit. Scheduling samples to different hardware units defines the movement of samples from hardware unit to hardware unit through the system.

Running one assay may require reformatting samples, conducting experiments on the samples, and analyzing experimental results to capture data. This will require process scheduler 416 to first determine the priority of each assay, the number of each assays to be performed, the order of assays to be performed and the availability of hardware resources such as reformatter workcell 108, assay workcell 110 and analyzer station 112 that are required to perform each assay. The process scheduler 416 first tentatively allocates an appropriate time slot to each of assigned reformatter workcell 108, assay workcell 110 and analyzer station 112 for the first assay, determined for example, from priority of the assays. The length of time for each time slot may be based on results of similar experiments previously performed by the same hardware unit, or may be specified by a user. Schedule conflicts may result when more and more assays are scheduled. Process scheduler 416 attempts to resolve these conflicts and produce an overall optimum scheduling of hardware resources. Through the schedule produced by process scheduler 416, process integration server 124 orchestrates the flow of both samples and data through the system 100.

It will be appreciated that such a schedule may be modified from a previous schedule for a similar testing request or even manually entered. For example, when a staff member at a testing facility receives a request to run five assays on a list of several hundred compounds, the user may determine first the order of these assays based how many compounds need to run the assay and whether there are other requests that require to ran the same assay as well. If so, these requests may be grouped together in the scheduling. In addition, some assay must be run after other assays, for example, because the subsequent assays rely on the results or experiment products of previous assays. Also may be taken into consideration is whether the results of any assay may eliminate many compounds. A set of rules for prioritizing and ordering assays may be established by a user based on the user's expertise. For example, the assay that needs to be run on the least number of compounds but can eliminate the most number of compounds generally has the highest priority and tends to be run first. These rules may be followed manually by a user if a schedule is established using a separate scheduling program, such as in the example described here. The staff member may use a scheduling program, such as Microsoft Project™ to enter the order of each assay, the anticipated time length of each assay, and any possible overlap of assays so that the scheduling program can produce a schedule. Such a schedule may also be used by software system 400. In one exemplary implementation of software system 400, the software services: for scheduling is provided by Microsoft Project™ that produces schedules entered by a user as described above and uses the schedule so produced to determine the recipients of messages at the conclusion of each assay.

Screening decision module 418 is a software service subsystem that examines information obtained from laboratory instrument subsystems, by way of their software service components or instrument cell subsystem 406 provided by process integration server 124. Screening decision module 418 applies heuristics to the determination of adjustments to subsequent laboratory process flows orchestrated with the process integration server 124. In one embodiment, these heuristics are “hurdle properties” for compounds, and are either automatically determined or adjustable in real time by the user or users making the decision on an ADME-Tox screen. Other heuristics can be used, such as method to pass control samples (such as test markers or “canaries”) through to subsequent tests, or to base the hurdle rate on the capacity of the downstream devices.

Workflow interface subsystem 420 is a subsystem that provides software services allowing laboratory personnel and research scientists to interact with the system, monitor the process of each experiment and the status of the laboratory instruments and initiation, modification and executing laboratory processes. Human intervention into the automated process such as overriding conventional heuristics, affords fine-detail customization of a laboratory process. To the extent that some elements of the orchestrated laboratory flow process are performed by laboratory personnel, and not laboratory instrument subsystems, inherent in such a configuration is the communication with such personnel by the orchestration components and the process integration server, during the course of initiating, adjusting, and executing the laboratory process. The communication may be in the form of e-mail messages, notification messages on a computer display, status indication displayed in a message window, an audio message or any other suitable form.

Once an assay is completed for a compound, the screening decision module 418 of the software system 400 makes a decision whether the compound should be passed. The decision is sent to hardware resources scheduled for the next step as a message. The next step may be further compound detection, other experiments, or sample preparation, for example, as scheduled. If the hardware resource for the next step is completely automated, the message may be in the form of a control signal to commence operation of the hardware unit. If the hardware resource for the next step is not completely automated, the message may be an e-mail message sent to a laboratory technician or a test facility staff responsible for the hardware unit so that that person may take the necessary steps to commence the operation of the hardware unit to start the next step. In case the decision is to fail the compound, there may not be any further steps to be performed on the compound, as described earlier. This helps to reduce the number of unnecessary testings and thereby speed up the screening process.

Information services module 422 is a subsystem that provides software services allowing the communication to users and allowing a user to interact with the software system Information services module 422 may direct a Web-browser-based software applications, software applications resident on either a fixed or wireless mobile networked computing device, or a display terminal directly controlled by information services module 422 to allow communication of system messages such as progress of experiments to users and to allow human interaction with an orchestrated laboratory workflow process. Controllability of operations and visibility of operating conditions and results within the automated laboratory occurs through the use of software application components. For example, information services module 422 receives input entered by a user from a data entry form on information portal 122 or an administration workstation 120 and then forwards the request to process scheduler 416 for scheduling an experiment. Information services module 422 can also request data from data warehouse 404 and present the data in a suitable format for user presentation. Status information may be presented on display terminal 118 or information portal 122. Information services module 422 may further distinguish the types of data and their respective intended user and present the data differently so as to tailor the portal presentation specific to users' particular roles within the screening laboratory. For example, information regarding status of various instruments, including assays being run on instruments or workstations, may be delivered to users by network messaging module 402 on information portal 122, without any restriction. On the other hand, test plans and modification thereof may be delivered to scientists in a trusted fashion, requiring user authentication, before a test plan may be viewed, entered or modified.

Results analytics module 424 provides the necessary data analysis services and is part of the data process module 114. Data generated by hardware units and acquired by their associated data acquisition software applications are analyzed by results analytics module 424. Results analytics module 424 typically has a statistics component for extracting statistical information from raw data. It may also have graphing components for visually presenting data. Data may be analyzed as the experiment is being conducted, for example, by periodically polling the hardware instrument for new data, or upon completion of the experiment. Results analytics module 424 may also process data in real-time and provide feed-back to the hardware unit for optimizing compound detection and data acquisition. For example, results analytics module 424 may analyze data streams from a LC-MS workstation, locate signal peaks, and provide feed-back to the LC-MS workstation so the detection parameters may be optimized in real-time. Results analytics module 424 may be custom programmed for those specific experiments conducted in laboratory, or may be adapted from commercially available data analysis software. Results analytics module 424 also makes experiment results available to laboratory personnel for viewing and process decision-making.

The integrated system allows a user to schedule hardware resources for running assays and to schedule the assays in such a way that tends to reduce the amount of assays and samples that need to be run. A user starts by selecting assays from a list of assays that will be used to profile the compounds. The user can specify the order in which the assays will be conducted, in order of priority based on the technical experience of the user. The process scheduler 416 programs the assays into the individual workcells and sample analyzing equipment for experiments, sample analysis and data acquisition. As completing one assay may require several hardware equipment, such as a reformatter workcell for sample preparation, an assay workcell for conducting experiment and a sample analyzer workstation for sample analysis and data acquisition, the user uses the process scheduler 416 to program a laboratory workflow specifying how data and the samples will move from hardware unit to hardware unit. Where not all hardware units are completely automated, the workflow also specifies how information regarding each requested experiment will flow from laboratory technician to laboratory technician who are responsible for these hardware units and the scheduling of their work time (i.e., task assignments of these laboratory technicians). The process scheduler 416 develops a schedule to coordinate the flow of data and samples, and the work time of laboratory where necessary.

It will be appreciated that the user who uses the process scheduler 416 to develop the schedule may not be the same user who will be running the experiments. A user may develop a schedule and then send the schedule and samples to another user or users for actually running the experiments. This permits efficient allocation of research resources. For example, an experienced user may be responsible for the scheduling of assays, while a less experienced staff member may be responsible for the actual running of experiments. This allows the experienced user to concentrate on the planning aspect of the experiments, which may require a better understanding of the overall requirements of drug screening and a more thorough understanding of the compound properties in general.

The user also needs to specify a test acceptance criteria, or “hurdle property”, for “promoting” a sample to the next scheduled assay. Failing a single test acceptance criteria may eliminate a compound immediately, without the need of continuing with other assays. A test acceptance criteria may also be accumulative in that only after failing a number of similar accumulative hurdle properties will the compound be eliminated. The process scheduler 416 may incorporate these conditions in the schedule so that the screening decision module 418 will make the decision automatically to determine whether to permit the compound to proceed (or, to be “promoted”) to the next as say. This allows the automatic running of all assays once the samples are provided to the system 100. Alternatively, the researcher can choose to be “in the loop” to help make the decision on the hurdle property while the results are being reported, as will be described below.

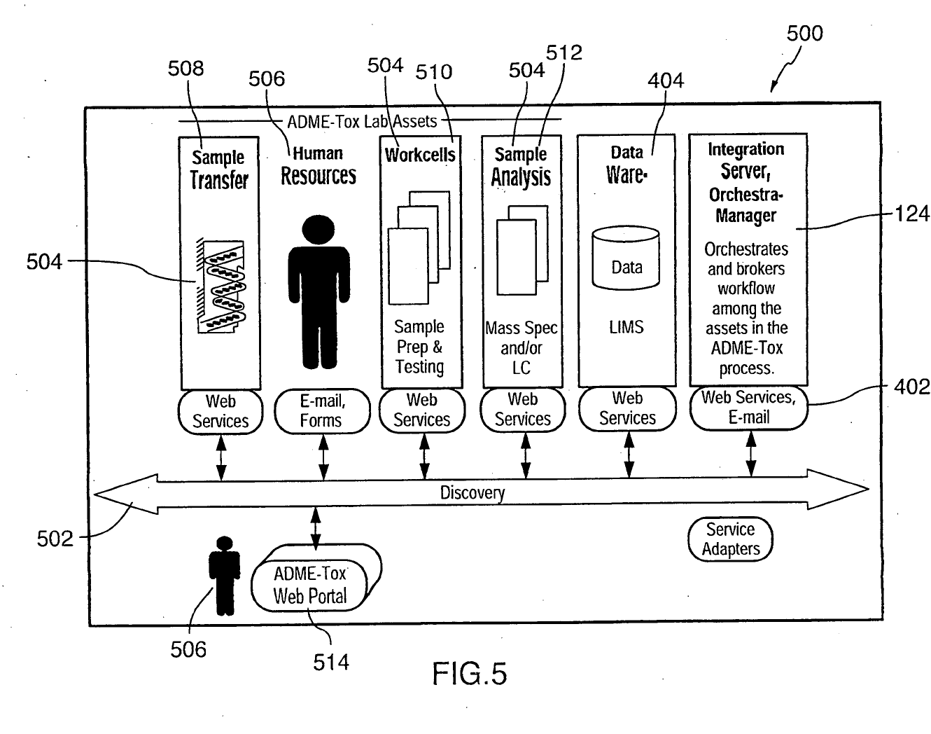

The hardware, software and IT portions of system 100 in combination support a drug discovery environment 500 as illustrated in FIG. 5. Central to this environment is interchange hub 502, or discovery bus. It is an interchange over which all the elements of drug discovery environment 500 interrelate and helps create a communication environment in which people, hardware instrumentation and software applications interact. The bus is logical or conceptual, rather than a physical bus such as a computer's bus or a telecommunication network. For example, in an actual ADME-Tox system, the bus may represent LANs and protocols, with which computer systems communicate. The bus may also represent messaging to and from laboratory personnel, as they participate with the systems in the ADME-Tox process. The bus is a link within the drug discovery environment 500 that allows each elements of the environment to communicate with each other elements. It ties everything together.

Each self-contained laboratory instrument subsystem 504, such as robotic automated cells, liquid chromatographs, and mass spectrometers, constitutes an individual laboratory service process. Each laboratory instrument system 504 interacts with other laboratory instrument system 504 and other elements in the drug discovery environment 500 through interchange hub 502. For example, laboratory personnel 506 interacts with process integration server 124 through interchange hub 502 in the form of e-mail messages and data entry forms. Various web services provided by network mess aging module 402 enables the initiation and completion of test procedures conducted by workcells, such as sample transfer 508, sample preparation and testing 510 and sample analysis 512. They may be in the form of web messages delivered to interchange hub 502, which messages are then processed by process integration server 124 and delivered to their respective destinations for further processing. A web portal 514 (or a display terminal, not shown in FIG. 5) is attached to interchange hub 502 for allowing a user, such as laboratory personnel 506, to monitor the progress of experiments. A user may also use web portal 514 to access the system to control the progress of the experiments, such as to pass or fail a compound for a particular assay, or series of assays based on results received from the system.

Process integration server 124 interconnects the individual laboratory instrument systems in orchestrating a process flow of activities that accomplish the laboratory objectives for drug compound screening. The laboratory process flow is determined and adjusted by the process integration server 124 according to data received from individual laboratory instrument systems, obtained as these systems perform their assigned test procedures during the flow. In particular, its process scheduler 416 determines the most appropriate scheduling of a process flow among a pool of independent instrument components, as needed to accomplish screening objectives.

The environment 500 may be supported by custom software, i.e., a programming of the entire software system 400 plus the software necessary for each instrument cell subsystem 406. Conveniently, commercially available software also Ray be used, with only what is necessary to integrate the commercially available software into the software system 400. As described earlier, commercially available Microsoft Project™ may be used to perform some of the functions of process scheduler 416. Similarly, BizTalk™ commercially available from Microsoft Corporation may be used to perform some of the functions required by process integration server 124 or workflow interface subsystem 420, for example.

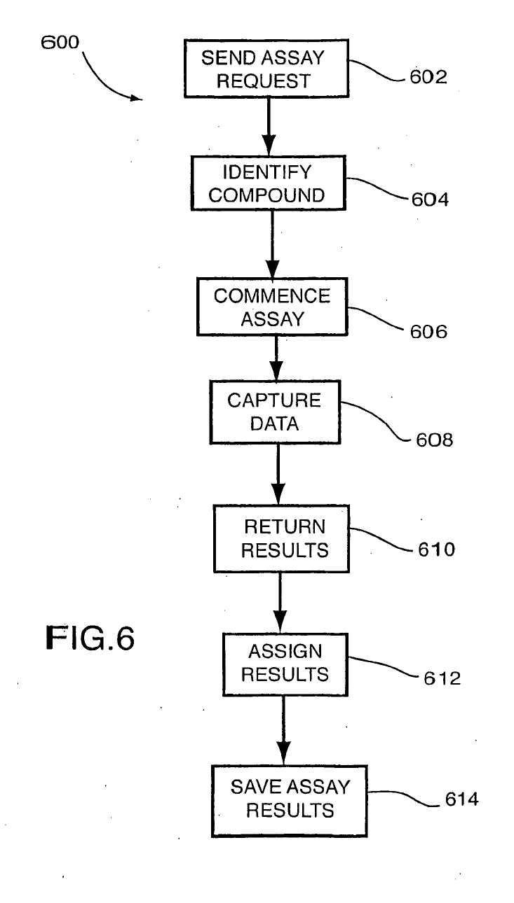

FIG. 6 provides an overview of a laboratory workflow process that can be defined by a user. Once defined, laboratory personnel and instruments may follow the steps defined in the workflow to carry out experiments. This encourages the establishment of standard experiment protocols across users, laboratories, and research departments. Briefly, the workflow 600 includes the steps of sending and receiving assay request 602, identifying compound 604, commencing assay 606, capturing data 608, returning assay results 610, assigning assay results 612, and saving assay results 614.

At the step of sending and receiving assay request 602, a user starts the workflow by sending an operation request. The request may also be sent automatically by the system. For example, when samples are delivered to a workcell, such as an LC-MS workstation for purity assay, upon checking in of the samples using a barcode reader, an XML form is sent from the LC-MS workstation and received by process integration server 124. The process integration server 124 using the message to identify the compound to be tested at the step of identifying compound 604 and the assay requested in order to schedule and instruct the appropriate workcell for performing the assay. At the step of commencing assay 606, a message (for example, in XML format) is sent to an appropriate hardware unit, such as assay workcell 110 to commence the requested assay. Data is captured during the performance of the assay at the step of capturing data 608 where possible. Certain data may only be collected upon completion of experiment. When all data are collected, assay results are returned from the hardware units to process integration server at a step of returning assay results 610. The returned assay results are assigned to the compound, namely associated with the compound, at the assigning assay results 612 step. The assay results, associated with the compound, are next stored in data warehouse 404 for later retrieval or further processing. Once such a generic workflow is defined, it may be executed by the hardware and software components of the drug screening system 100 over and over again.

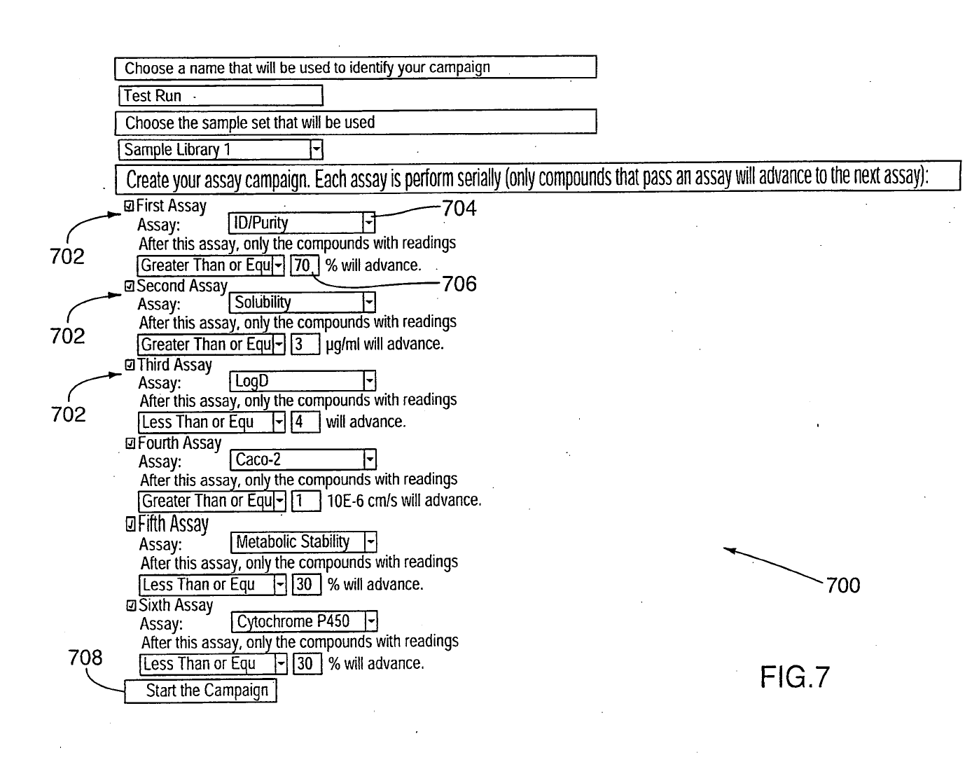

FIG. 7 shows an exemplary screen display produced by the software system 400. The screen display shows a data entry form. A user of the system 100, such as a researcher, may user the data entry form to define a screening campaign. A series of assays are run in a screening campaign. Each assay is assigned a test acceptance criteria, or hurdle property. The goal of a screening campaign is to identify compounds that pass all the hurdle properties outlined at the beginning of the screening process. The assays and the corresponding test acceptance criteria may be entered from the screen display. The screen display may be displayed on a computer screen by information portal 122 as a web page, or transmitted for displaying on a handheld device. A user starts by requesting, i.e., specifying what assays to do for each compound. For each assay, the user specifies the experimental procedures to be performed or selects a specific protocol. The user also needs to determine a test acceptance criteria for determining whether the compound passes or fails the assay. The user may pick the order each assay is run, for example, in order of priority based on the technical expertise of the user. Alternatively, the user may specify simply the interdependencies of the assays and let the software system 400 to work out a schedule. The user may also specify to terminate the process if one of the assays fails. These are entered into the system and saved to data warehouse 404 as test plan.

The screen display shown in FIG. 7 is an exemplary entry form 700 for defining a series of assays that need to be run in a screening campaign. Appropriate hurdle rates for each assay can be selected. In this example, six selectable assay entry cells 702 are provided (first three of them are labeled). A user can select from a drop-down list 704 in each assay entry cell a desired assay or manually enter an assay. A test acceptance criteria, or hurdle property, is selected or entered in the acceptance criteria box 706. The test acceptance criteria may be set for the result reading to be above a threshold value, below a threshold value, or within an acceptance window. After test acceptance criteria for the desired number of assays are entered, the user can request the system 100 to schedule the screening campaign by pressing a “Start the Campaign” button 708, or using other suitable means. Process integration server 124 passes the request to process scheduler 416, which produces a schedule based on availability of hardware units and estimated time required for each assay.

The decision whether a compound passes an assay is generally made by the system based on test acceptance criteria specified and test results returned from hardware instrument and processed by results analytics module 424. The system 100 also provides a user with the control whether to pass a compound for an assay. A user can decide to fail a compound even if the test results meet the test acceptance criteria or vice versa. This provides the flexibility allowing a user such as a scientist to incorporate his or her expertise into the decision making process and to have more control over the drug screening process.

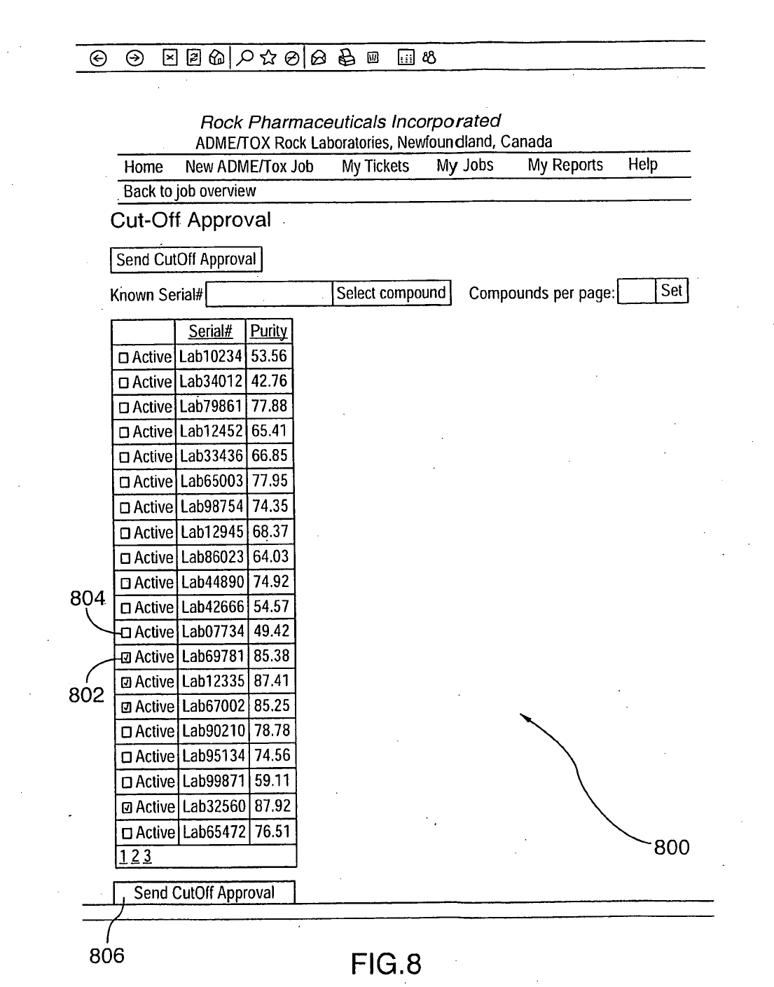

FIG. 8 shows another exemplary screen display 800 from which the user may enter or modify a decision on passing a compound for a purity assay. The exemplary screen display 800 shows the purity results for a number of compounds. Each compound has a designated serial number so the system can track and store results. The test acceptance criteria, i.e., test cut-off, in this case is set at 80%. From exemplary screen display 800, it can be seen that several compounds have passed the assay, as indicated by a checked checkbox 802 shown next to the corresponding serial number. Others have unchecked checkbox 804, indicating that the compounds failed the assay. The system 400 makes the initial decision whether a compound will pass based on the test acceptance criteria specified for each compound A compound having the checkbox checked will proceed to the next assay. A compound having its checkbox unchecked may not proceed to the next assay. If the test plan specifies that a compound will be eliminated immediately upon failing the assay, the unchecked compound will be eliminated from all subsequent assays. If the test plan specifies that a compound will be eliminated if it fails certain number of assays or a set of specified assays, the screening decision module 418 will determine whether the compound has failed the pre-determined number of assays or all of the assays in the specified set and decide whether to eliminate the compound from further screening. A user may uncheck a checked checkbox 802 or check an unchecked checkbox 804 to override the system decision. After a user is satisfied which compounds should pass or fail the as say despite the test results, the user press the confirmation button 806 labeled “Send CutOff Approval” to confirm the system decision or to commit the changes made through the form shown in exemplary screen display 800.

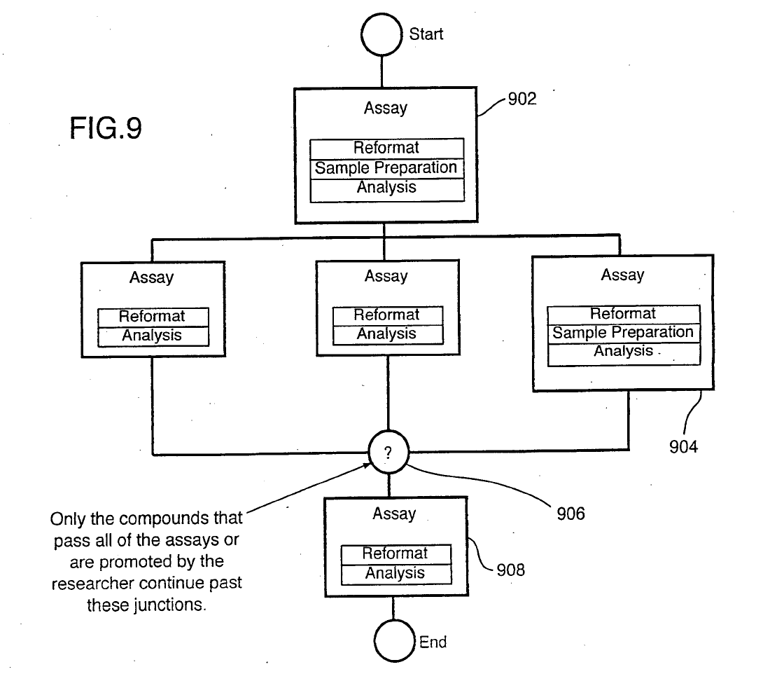

Assays may be run in serial. Assays also may be run in parallel if no dependency is specified or known to the system. Where dependency exists, the process scheduler 416 attempts to optimize the schedule by scheduling as many assays as possible in parallel, such as that shown in FIG. 9. FIG. 9 is a diagram showing in detail a portion of screening campaign running assays in a combination of parallel and serial steps. A total of five assays are shown. In this example, the rest of assays depend on the completion of first assay 902. First assay 902 is therefore the first to run. The next group, second, third and fourth assays 904, are independent of each other and therefore are run in parallel Running assays in parallel helps to maximize utilization of hardware resources such as workcells and instruments and reduce their idle time. It will be appreciated that although the assays are shown to be performed in parallel, they are performed in parallel logically and may not be necessarily parallel in time. Upon completion of second, third and fourth assays 904, results of each assay are evaluated to determine whether to pass all or only some of the assays. At decision point 906, such decision may be made by the system or may be by a user. Only the compounds that pass all the assays, namely first assay 902 at the first serial step and second, third and fourth assays 904 at the parallel step, will be promoted to the next serial step for the fifth assay 908.

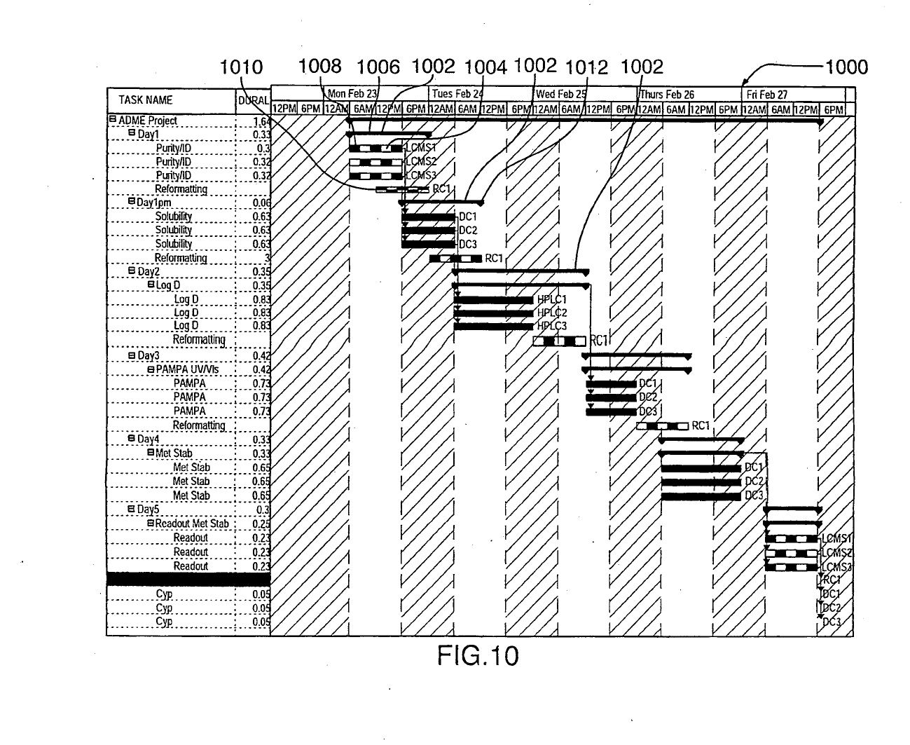

FIG. 10 shows an exemplary scheduling diagram 1000 produced by process scheduler 416. Six assays are scheduled, as indicated by six assay bars 1002 (first three are labeled). Each of the assay bars 1002 corresponds to a scheduled time slot for an assay. An instrument bar 1004 under each assay bar indicates an instrument required for an experimental step. For example, the left-most assay bar, or first assay bar 1006, has three instrument bars labeled “LCMS” and one instrument bar labeled “RC”. The presence of three LCMS instrument bars 1008 indicates that three LC/MS workstations in total are required to run a mass spectrometry analysis on all samples, with each LC/MS workstation responsible for one third of the total samples. The presence of one RC instrument bar 1010 indicates that only one reformatter workcell 108 is scheduled for reformatting all samples after the mass spectrometry analysis.

The scheduling diagram 1000 also shows that the RC instrument bar 1010 labeled “RC” starts before the LCMS instrument bars 1008 finish. This indicates progressive reformatting. Through the communication with process integration server 124, reformatter workcell 108 is provided with a running list of compounds in a continuous stream that have passed a test acceptance criteria for an assay. As results come in, requests for reformatting of these compounds for subsequent assays is passed to reformatter workcell 108. This allows reformatter workcell 108 to build assay specific pick lists dynamically at runtime upon completion of experiment procedure of each sample, rather than the completion of the entire batch of samples. Assay plates are accumulated progressively in separate temporary storage places, or “hotels”, for each of the active assays. Essentially, reformatter workcell 108 is engaged at a steady rate rather than in bursts of sample preparation. Idle time of hardware components is minimized.

Also shown in FIG. 10 is the overlap of first assay bar 1006 and second assay bar 1012, labeled. “DC” for “sample preparation/testing”. This overlap and therefore reduction of idle time is achieved again, by optimally scheduling the starting time of each assay and coordination of hardware units, in a similar fashion as described above.

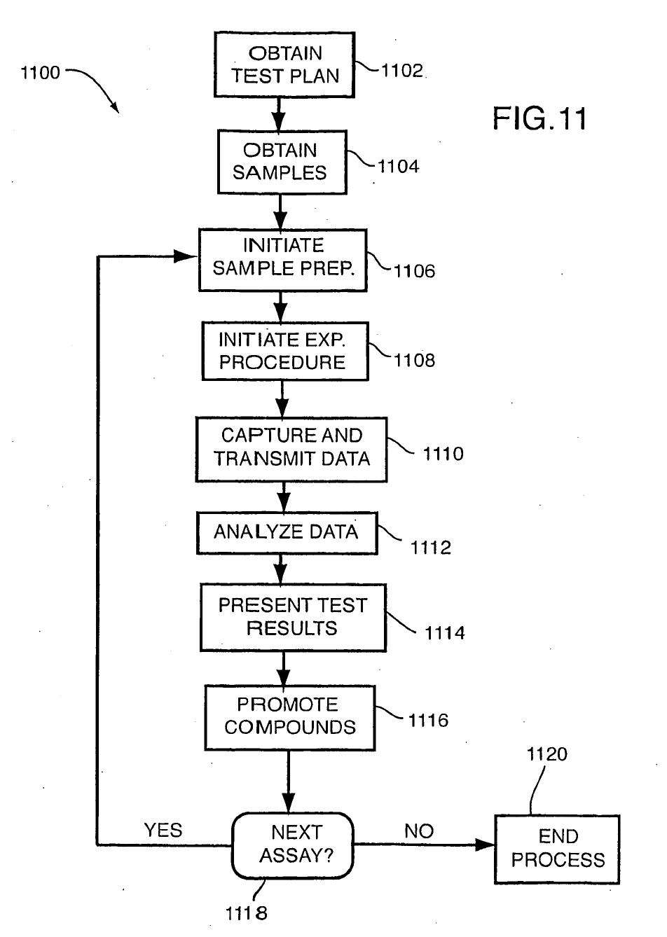

Referring to FIG. 11, there is shown a diagram in flowchart format for a drug screening process 1100 that is implemented by the software system 400 and IT components of drug screening system 100. The process has the following steps as will be described in greater detail below: obtaining test plan 1102, obtaining samples 1104, initiating sample preparation 1106, initiating experiment procedures 1108, data acquisition 1110, performing data analysis 1112, optionally presenting test results 1114 to a user of the system, deciding compounds promotion 1116, making subsequent assay decision 1118, and process termination 1120.

The process starts by obtaining a test plan related to the screening campaign at an obtaining test plan 1102 step. The test plan is pre-entered by a user, for example, using the data entry form 700 shown in FIG. 7, or modified from a previous test plan using suitable data entry means. As described, the test plan contains a specification of assays to do for each compound and test acceptance criteria for passing the compound. Interdependencies of the assays may be specified so the system can determine whether to terminate the process if one of the assays fails or whether some of the assays can be run in parallel in order to shorten the time required to run the campaign. Test procedures and experiment protocols may also be defined or specified. The test plan is retrieved at the obtaining test plan 1102 step.

Referring to FIG. 11, once a pre-defined test plan is retrieved, the system 100, at an obtaining samples 1104 step, determines the samples of compounds required for executing the test plan and confirms that samples are arrived and placed in one of reformatter workcell 108. Samples may be selected from a master library and placed in reformatter workcell 108 by laboratory personnel, or more preferably, selected by robotic devices and transported to reformatter workcell 108 automatically. Selected samples may be identified by labeling means such as barcode labeling where it is provided.

Upon confirmation that samples are in reformatter workcell 108, process integration server 124 sends a web service message to the instrument cell subsystem 406 responsible for reformatter workcell 108. The instrument cell subsystem 406 instructs reformatter workcell 108 to prepare data plates for the requested assays at an initiating sample preparation 1106 step. Reformatter workcell 108, through its instrument cell subsystem 406, informs process integration server 124 when sample preparation is completed. In a semi-automated system, process integration server 124 sends an e-mail message to laboratory personnel, updates the status information presented in information portal 122, or otherwise notifies user of the completion of sample preparation so that the laboratory technician may transport the prepared samples to assay workcell 110 for testing. If barcode or other labeling technology is used, a reader may be employed to check in and check out the samples as they are moved from workcell to workcell. Process integration server 124 may then records the location of each sample, thus providing location tracking of each samples as they move from hardware unit to hardware unit. Preferably, in an automated system, process integration server 124 directs a transport system to move the prepared samples from reformatter workcell 108 to assay workcell 110 and records the movement and location of each sample.

Experiments are conducted at assay workcell 110. An instrument cell subsystem 406 responsible for assay workcell 110 is instructed by process integration server 124 to start the experiments at an initiating experiment procedures 1108 step. Experiment procedures specified in the test plan or steps in the protocol selected for the test plan are followed by instruments and devices of assay workcell 110, such as robotic devices and liquid handling devices, in an automated fashion. Upon completion of all procedures, the instrument cell subsystem 406 notifies process integration server 124, for example, by sending a notification message. Again, in a semi-automated system, process integration server 124 may notify the user of the completion of the experiment by sending an e-mail message, updating the status information presented in information portal 122, or by employing some other suitable means. The e-mail message may simply provide status information. It may also include an experiment report to provide more detailed information about the assay or experiment completed. Any other suitable audio or visual means may be utilized to provide the notification.

As described earlier, either dedicated software or instrument cell subsystem 406 responsible for a workcell or workstation captures experiment results and transmits the captured data to process integration server 124 for saving to data warehouse 404. Data acquisition 1110 is performed either when the experiment procedures are being conducted or at the conclusion of the experiment procedures, depending on the nature of assay and the experiment procedures. Once the results are captured, they are stored in data warehouse 404. They may be stored immediately as raw data or may be processed first as described below and then made available to scientists as processed data.

Next, process integration server 124 waits for results from analytics module 424 to analyze the raw data. The results analytics module 424 polls the hardware units periodically for new data. Once a hardware unit has new data available, in a data analysis 1112 step, the results analytics module 424 processes the raw data and extracts information from the data. Data analysis operations may include statistical analysis of the data, reformatting data for sharing with other components of the system or other users, as well as preparing data for visualization. Results of data analysis 1112 are also stored in data warehouse 404. At the step of presenting test results 1114, these results are made available to users and laboratory personnel. The results may be “pushed” to the users by updating a status screen display constantly as each results of assay become available; they may also be “pulled” by users as a response to request for data or assay results.

At compounds promotion 1116 step, process integration server 124 retrieves the results of the assay and forward the results to its screening decision module 418. At least the relevant test acceptance criteria for the assay is also forwarded to or made available to screening decision module 418. Based on the assay results and the test acceptance criteria, screening decision module 418 makes an automated decision whether to promote all, some or none of the compounds. A sample is to be “promoted” if its test results pass the pre-determined test acceptance criteria. A promoted compound will have further assays performed thereon. If its test results fail the test acceptance criteria, the sample of the compound may be eliminated from further screening. In general, a compound is eliminated from further screening if it failed a specified set of assays. A special case is for the compound to fail a single assay. As discussed earlier, in general, the decision to eliminate a compound is made accumulatively on the failure of several assays. The controlling factor may be the number of assays in the specified group, or the failure of all assays in a smaller group. How the accumulative decision is to be made is determined by a user, such as a scientist, before the screening is started. If a compound is not to be promoted, no further assays will be performed on the failed compound. The compound will be removed from the schedule for further testing. In which case, none of the hardware components that are scheduled to perform further tests on the failed compound will be requested to perform the cancelled tests. Alternatively, a message may be sent to all such hardware components to explicitly cancel further testing, or to all staff members who would otherwise test the failed compound as scheduled. This tends to reduce the wasted time and resources spent unnecessarily on compounds that already known to be unsuitable.

However, whatever the decision is rendered by the software system 400, the decision may be reviewed and modified by a user as described below. At the step of deciding subsequent assay 1118, process integration server 124 will terminate the testing process, i.e., screening campaign, at step 1120, unless there is at least one remaining assay to be performed on promoted samples. The decision to start a subsequent assay may be made automatically, as described above at the compounds promotion 1116 step. Factors considered include whether at least one assay still needs to be performed on the promoted compounds and, if a subsequent assay is to be performed, whether the subsequent assay is to be performed in parallel or serial. The decision to start a subsequent assay may also be evaluated by users. A user may access integration server 124 through information portal 122, from which the user can review the results of current assay or all assays performed thus far and then decide whether to commit the system to the next assay. Test or assay results as well as test acceptance criteria may be reviewed along with the machine-made decision. The user may confirm the automatically rendered decision. The user may also use his or her own judgement to decide whether to modify, namely manually override, the automatically rendered decision.

In case a further assay is to be performed, the process returns to the step of initiating sample preparation 1106. Namely, process integration server 124 instructs reformatter workcell 108 to prepare the requisite plates for the next assay and the process will be repeated from there.

In operation, a user of the system 100 such as a user starts the process by entering a test plan for a screening campaign. The user specifies the assays required for the screening campaign. The user requests or specifies for each compound included in the screening campaign what assays to do, and may also specify whether to do one assay depending on the results from another. At a laboratory, samples arrive and are placed in the reformatter workcell. Process integration server 124 instructs reformatter workcell 108 to prepare sample plates for the requested assays. Prepared samples are transported to assay workcell 110 so experiments are conducted at the assay work cell 110. The software records experiment conditions and captures experiment results. Samples may also be transported to analyzer station 112 for further compound detection and data acquisition. The captured experiment results are analyzed. Both raw data and analyzed data are then made available and are presented to the user when desired. Software system 400 also makes decisions about which assay to perform next for each sample based on the test results and the test plan and instructs the reformatter workcell 108 to prepare the requisite plates for the next assay. The entire process may be automated. A user also may evaluate the experiment results in real-time as the experiments are conducted and intervene at key decision points to decide whether to continue, terminate, or modify the steps for the screening campaign. This process can be repeated over and over again for different sets of compounds or samples.

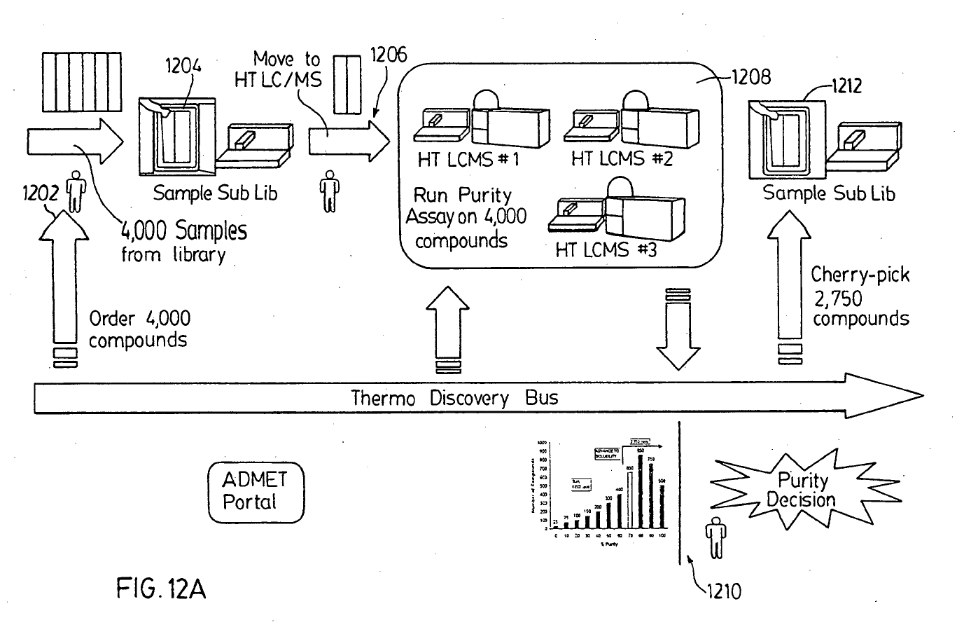

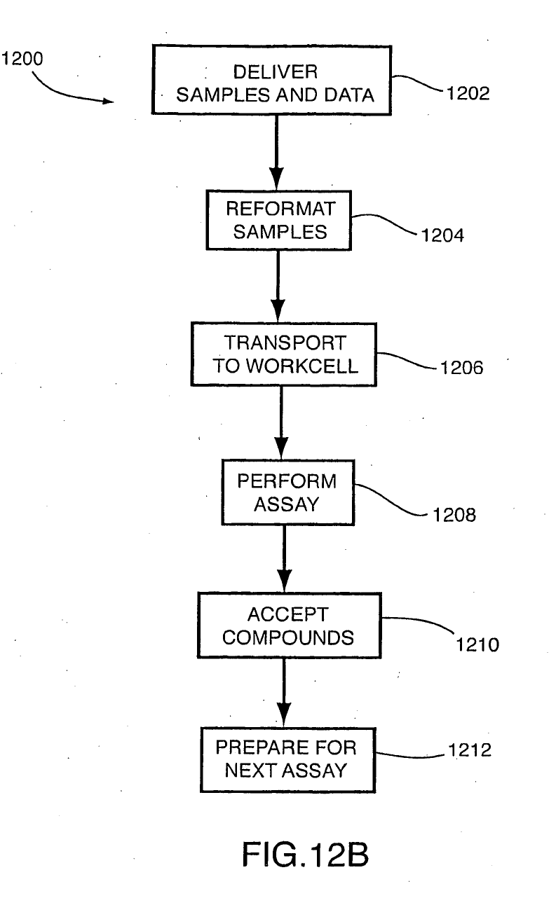

The process described with reference to FIG. 11 is implemented to conduct a screening campaign, in which multiple assays may be performed on a single candidate compound. The following is an example illustrating the steps followed by the drug screening system 100 in performing a single assay on a set of compounds. FIG. 12A illustrates schematically the steps of a process for performing an assay as seen in the drug discovery environment 500 shown in FIG. 5; FIG. 12B shows steps of the process in a flowchart format. In one implementation, this represents the process for performing the first assay represented by first assay bar 1006 in FIG. 10.

The steps are as follows. First, at step 1202, the compounds to be screened by the assay are delivered to the drug screening system 100 from a master library, in a set of formatted microplate plates, together with the data corresponding to each of the compounds. Next, at step 1204, reformatter workcell 108 labeled “SampleSubLib” in FIG. 12A reformats these samples into the appropriate microplate plates. At step 1206, reformatted samples are transported to the appropriate work-cell or workstations for performing the assay, either by a robotic transport device or moved by a laboratory technician. For example, a technician may move the microplates, arrayed in a standard container format, from the SampleSubLib to the first assay. In this case, the purity assay uses the LC/MS workstations, as indicated by three instrument bars 1004 shown in FIG. 10. In other cases, technicians may load the necessary assay reagents and consumables for the assay as necessary.

The purity assay commences at step 1208. As purity data is being obtained, decisions will start to be made on whether a compound passes the property hurdle or not at step 1210. The system 100 can automatically make the decision based on assay results and the property hurdle, or test acceptance criteria, predefined in the test plan. Scientists may also be involved in the decision-making process, and thus will have the ability to vary the hurdle rates, or choose other heuristics to pass compounds to the next stage.

In case at least one compound passes the property hurdle, the system 100 at step 1210 automatically starts passing information on to the reformatter workcell 108, i.e., SampleSubLib, through the process integration server 124, in order to start reformatting microplates for the subsequent assay. The SampleSubLib formats all the passed compounds into new microplates as directed and makes them available for the next assay, stored in standard container formats.

Other assays scheduled in a scheduling diagram 1000 shown in FIG. 10 and defined using an assay campaign entry form 700 shown in FIG. 7 can be similarly performed by the system 100. For example, after the purity assay is completed, the solubility assay may be performed the next day following a process similar to that shown in FIG. 12B, except that the first two steps are not necessary, as the samples are already delivered at the start of the screening campaign and the remaining samples are already reformatted at step 1210 during the previous assay. All assays will be performed as scheduled as more and more compounds are eliminated for unable to pass the specific property hurdles set for each assay.

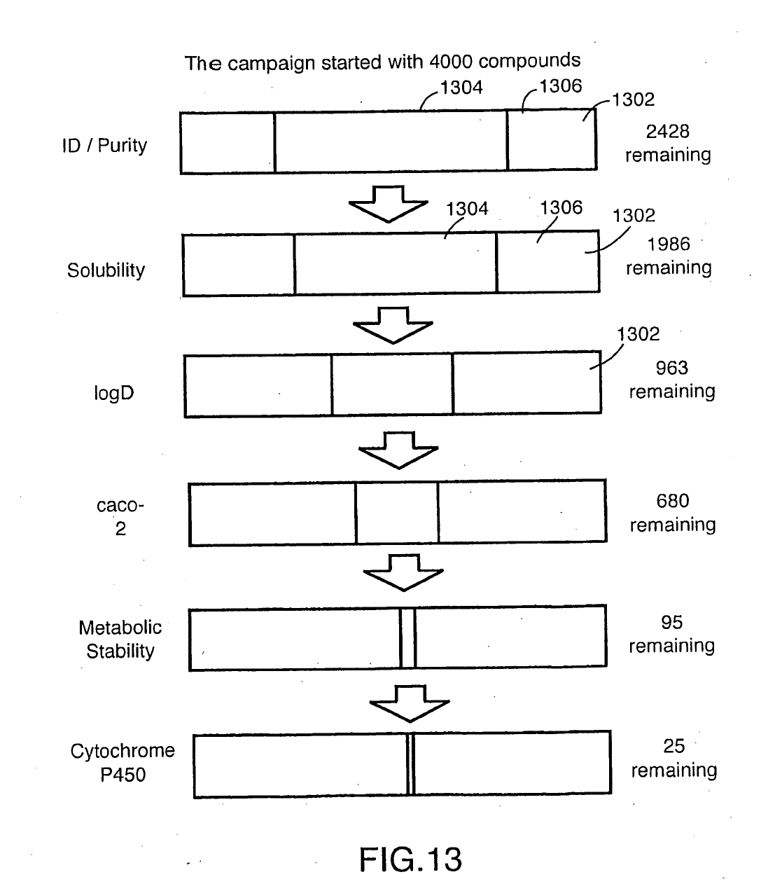

FIG. 13 illustrates schematically the gradual reduction or elimination of drug candidates. A screening process having six different assays has been run. Corresponding to each assay is an assay result bar 1302. Assay result bar 1302 has two parts, a central region 1304 and an outer part 1306. In FIG. 13, outer part 1306 is shown to have two halves flanking central region 1304. The ratio of the widths of central region 1304 and total widths of outer part 1306 provides a visual indication of the passing rate. These two parts may be color coded differently for better visualization effect.

In this example, FIG. 13 shows that out of the 4,000 candidate compounds at the beginning, 25 remain at the end of the screening campaign. These remaining 25 compounds have passed all the hurdle properties of the tested assays. The central region 1304 of successive assays forms a “funnel”, i.e., progressively narrower central regions on each assay result bar 1302. From information portal 122 or display terminal 118, a user may view the forming of “funnel”, i.e., the progressive “funneling” of compounds while a screening campaign is in progress. This provides the user another visual cue as to the effectiveness of the screening campaign.

Various embodiments of the invention have now been described in detail. Those skilled in the art will appreciate that numerous modifications, adaptations and variations may be made to the embodiments without departing from the scope of the invention. Since changes in and or additions to the above-described best mode may be made without departing from the nature, spirit or scope of the invention, the invention is not to be limited to those details but only by the appended claims.

1. A system for orchestrating laboratory functions on samples to be tested, the system comprising:
a library of samples;
a user interface for receiving one or more requests from users, each of said requests identifying one or more tests to be conducted on at least one of said samples from said library;
a reformatter for creating a sublibrary of said samples, the sublibrary comprising those samples for which a chosen test is to be conducted;
a scheduler for assigning the sublibrary to a laboratory resource for performing said chosen test, the laboratory resource comprising at least one of hardware resource and a laboratory operator; and
a process server for directing the laboratory resource to perform the chosen test assigned by the scheduler, the process server having:
a means for monitoring the status of the laboratory resource and location and states of the sublibrary,
a message module for providing communication between the process server and at least one of the laboratory resource, the user interface, the reformatter, and the scheduler, and
a control module for directing the message module to send a message to the laboratory resource to initiate said chosen test.

2. The system of claim 1, wherein one or more of said requests includes a test acceptance criteria associated with at least one of the tests, and wherein the process server further comprises a decision module for determining whether a test result of one sample of the sublibrary meets the associated test acceptance criteria.

3. The system of claim 2, wherein the process server is configured to receive the test result and to send a reformatter message to the reformatter to create another sublibrary including the one sample upon the test result meeting the associated test acceptance criteria.

4. The system of claim 3, wherein the process server is configured to send the reformatter message to create another sublibrary in real time.

5. The system of claim 2, further comprising a memory means for storing a reference to the one sample that has the test result meeting the associated test acceptance criteria, wherein the process server is configured to send a reformatter message to the reformatter to create another sublibrary when the memory means has a pre-determined number of said references stored therein, said another sublibrary including the pre-determined number of samples, the test results of the pre-determined number of samples meeting the associated test acceptance criteria.

6. The system of claim 1, further comprising a memory means for storing status information, said status information being chosen from the group comprising the status of the laboratory resource, the location of the sublibrary, the location and status of the samples contained in the sublibrary, the status of the sublibrary, test conditions and test results of each sample of the sublibrary.

7. The system of claim 1, wherein the user interface is configured for presenting the status information in a graphical format.

8. The system of claim 2, wherein the tests identified in said requests are provided with interdependencies, said interdependencies comprising a hierarchical structure, a parallel relationship, a sequential relationship, a branch relationship, and a combination thereof.

9. The system of claim 2, wherein the request identifies at least a first test and a second test and wherein the scheduler is configured to receive a test result of the first test so that the scheduler schedules said second test when the result of the first test meets the test acceptance criteria associated with the first test.

10. The system of claim 1, wherein the user interface is configured for providing said one or more requests for review by a user and for receiving a modification request to modify the tests on a sample from the user.

11. A computer based method of orchestrating laboratory functions on samples to be tested, the method comprising the steps of:
providing a library of samples,
receiving one or more requests from users, each of said requests identifying one or more tests to be conducted on at least one of said samples from said library,
creating a sublibrary utilizing a reformatter, the sublibrary comprising those samples for which a chosen test is to be conducted,
assigning the sublibrary to a laboratory resource for performing said chosen test, the laboratory resource comprising at least one of hardware resource and a laboratory operator, and
sending a message to the laboratory resource to initiate said chosen test.

12. The method of claim 11, wherein one or more of said requests includes a test acceptance criteria associated with at least one of the tests, the method further comprising the steps of:
receiving from the laboratory resource a test result of one sample of the sublibrary, and
comparing the test result with the associated test acceptance criteria.

13. The method of claim 12, further comprising the steps of, upon the test result meeting the associated test acceptance criteria,
creating a second sublibrary including the one sample, and
assigning the second sublibrary to another laboratory resource for performing another of said tests.

14. The method of claim 12, Her comprising the steps of, upon the test result meeting the associated test acceptance criteria,
in a loop, storing a reference to said one sample until a predetermined number of references to said samples are stored, the test results of said pre-determined number of samples meeting the associated test acceptance criteria,
creating a second sublibrary including said pre-determined number of samples, and
assigning the second sublibrary to another laboratory resource for performing another of said tests.

15. The method of claim 11, further comprising the step of notifying a user upon termination of a request of the requests received from the user.

16. The method of claim 11, further comprising the steps of generating a test report upon termination of a request of the requests received from a user and communicating said test report to the user.

17. The method of claim 11, further comprising the step of tracking and monitoring the status of the laboratory resource and location and status of the sublibrary and the samples contained therein.

18. The method of claim 17, further comprising the step of storing status information, the status information being chosen from the group comprising the status of the laboratory resource, the location of the sublibrary, the status of the sublibrary, the location and status of the samples contained in the sublibrary, test conditions and test results of each sample of the sublibrary.

19. The method of claim 18, further comprising the step of communicating the status information to the user.

20. The method of claim 19, wherein the status information is communicated in a graphical format.

21. The method of claim 19, wherein the status information is communicated in real time.

22. The method of claim 11, wherein the tests identified in said requests are provided with interdependencies, said interdependencies comprising a hierarchical structure, a parallel relationship, a sequential relationship, a branch relationship, and a combination thereof, and the method further comprising the step of:
determining from said interdependencies an order of conducting said tests prior to the creation of the sublibrary.

23. The method of claim 12, wherein the request identifies at least a first test and a second test and the method further comprising the steps of, upon the result of the first test meets the test acceptance criteria associated with the first test:
creating a second sublibrary, said second library comprising samples for which said second test is to be conducted,
assigning said second sublibrary to a second laboratory resource, and
sending a second message to the second laboratory resource to initiate said second test.

24. The method of claim 11, further comprising the step of providing a request of said one or more requests to a user for review.

25. The method of claim 23, further comprising the steps of receiving a modification request from the user and modifying the tests on a sample according to the modification request.
